(19) United States
(12) Patent Application Publication
(10) Pub. No.: US 2026/0162403 A1
(43) Pub. Date: Jun. 11, 2026

(54) ELECTRONIC DEVICE AND CONTROL METHOD THEREOF

(71) Applicant: Samsung Electronics Co., Ltd., Suwon-si (KR)

(72) Inventors: Sungjin PARK, Suwon-si (KR); Youngbok SHIN, Suwon-si (KR); Subhransu Sekhar MOHANTY, Suwon-si (KR)

(21) Appl. No.: 19/412,234

(22) Filed: Dec. 8, 2025

Related U.S. Application Data
(63) Continuation of application No. PCT/KR2025/020193, filed on Nov. 28, 2025.

(30) Foreign Application Priority Data
Dec. 5, 2024 (KR) 10-2024-0179482

(51) Int. Cl. G06V 10/74; G06V 10/75

(52) U.S. Cl. CPC G06V 10/761; G06V 10/757; G06V 2201/02; G06V 2201/07

(57) ABSTRACT

An electronic device is provided. The electronic device includes a communication interface, a camera, memory, including one or more storage media, storing instructions, and at least one processor communicatively coupled to the communication interface, the camera, and the memory, wherein the instructions, when executed by the at least one processor individually or collectively, cause electronic device to obtain a camera-captured image of a target electronic device obtained by camera-capturing an image of the target electronic device among a plurality of external electronic devices by using the camera and camera-capture time information corresponding to the camera-captured image, obtain a screen-captured image and screen-capture time information corresponding to the screen-captured image from each of the plurality of external electronic devices through the communication interface, compare image similarity between the camera-captured image and the screen-captured image obtained from each of the plurality of external electronic devices based on the camera-capture time information and the screen-capture time information, and identify an external electronic device selected from the plurality of external electronic devices based on the image similarity as the target electronic device, and perform communication connection with the selected external electronic device.

### CROSS-REFERENCE TO RELATED APPLICATION(S)

This application is a continuation application, claiming priority under 35 U.S.C. § 365(c), of an International application No. PCT/KR2025/020193, filed on Nov. 28, 2025, which is based on and claims the benefit of a Korean patent application number 10-2024-0179482, filed on Dec. 5, 2024, in the Korean Intellectual Property Office, the disclosure of which is incorporated by reference herein in its entirety.

### BACKGROUND

### 1. Field

The disclosure relates to an electronic device and a control method thereof. More particularly, the disclosure relates to an electronic device for identifying a target electronic device by using a camera-captured image obtained by camera-capturing an image of the target electronic device, and a control method thereof.

### 2. Description of Related Art

Electronic devices that may provide various functions have been widely used. These electronic devices may have differences functions or contexts capable of being provided. Accordingly, the electronic device may use a function or context of another device by performing communication connection or interworking with an external electronic device.

A user may select a device to which the user wants to connect the communication by using a menu or list displayed on the electronic device. In this case, the user needs to know information of the device to which the user wants to connect the communication to perform the communication connection with a specific device among the external electronic devices.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a control method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a communication interface, a camera, memory, including one or more storage media, storing instructions, and at least one processor communicatively coupled to the communication interface, the camera, and the memory, wherein the instructions, when executed by the at least one processor individually or collectively, cause the electronic device to obtain a camera-captured image of a target electronic device obtained by camera-capturing an image of the target electronic device among a plurality of external electronic devices by using the camera and camera-capture time information corresponding to the camera-captured image, obtain a screen-captured image and screen-capture time information corresponding to the screen-captured image from each of the plurality of external electronic devices through the communication interface, compare image similarity between the camera-captured image and the screen-captured image obtained from each of the plurality of external electronic devices based on the camera-capture time information and the screen-capture time information, and identify an external electronic device selected from the plurality of external electronic devices based on the image similarity as the target electronic device, and perform communication connection with the selected external electronic device.

The instructions, when executed by the at least one processor individually or collectively, further cause electronic device to control the communication interface to transmit a signal for requesting the screen-captured image and the screen-capture time information to each of the plurality of external electronic devices while the image of the target electronic device is camera-captured using the camera.

The memory stores the plurality of camera-captured images obtained during a predetermined time and the plurality of camera-capture time information respectively corresponding to the camera-captured images. The instructions, when executed by the at least one processor individually or collectively, further cause electronic device to obtain matching time information by selecting the camera-capture time information matching the screen-capture time information from the plurality of camera-capture time information if the screen-captured image and the screen-capture time information are obtained from each of the plurality of external electronic devices, and identify the target electronic device by comparing the similarity between the camera-captured image corresponding to the matching time information and the screen-captured image.

The instructions, when executed by the at least one processor individually or collectively, further cause electronic device to transmit a signal for requesting keypoint information of an image displayed on each screen and detection time information corresponding to the keypoint information to each of the plurality of external electronic devices through the communication interface, obtain keypoint information of the camera-captured image, and identify the target electronic device by comparing image similarity between the keypoint information obtained from the external electronic device and the keypoint information of the camera-captured image if the keypoint information of each screen image and the detection time information are obtained from each of the plurality of external electronic devices.

The instructions, when executed by the at least one processor individually or collectively, further cause electronic device to select an external electronic device whose image similarity is greater than or equal to a reference value from the plurality of external electronic devices, and identify the selected external electronic device as the target electronic device.

The instructions, when executed by the at least one processor individually or collectively, further cause electronic device to control the communication interface to periodically transmit a signal for requesting the screen-captured image and the screen-capture time information to each of the plurality of external electronic devices if the external electronic device whose image similarity is greater than or equal to the reference value is not selected from the plurality of external electronic devices, and identify the target electronic device by comparing the similarity between the screen-captured image periodically received from each of the plurality of external electronic devices based on the screen-capture time information and the camera-captured image.

The memory stores a prior camera-captured image information obtained by previously camera-capturing the images of the plurality of external electronic devices. The instructions, when executed by the at least one processor individually or collectively, further cause electronic device to identify the target electronic device by comparing similarity between a background image included in the prior camera-captured image information of the selected external electronic device and a background image included in the camera-captured image if the plurality of external electronic devices selected based on the image similarity are included in the plurality of external electronic devices.

The prior camera-captured image information includes identity information of each external electronic device.

The instructions, when executed by the at least one processor individually or collectively, further cause electronic device to select one external electronic device based on signal strength information between the electronic device and the selected external electronic devices if the plurality of external electronic devices selected based on the image similarity are included in the plurality of external electronic devices, and identify the selected one external electronic device as the target electronic device.

The device further includes a distance sensor for detecting a distance between the electronic device and the plurality of external electronic devices. The instructions, when executed by the at least one processor individually or collectively, further cause electronic device to select one external electronic device based on distance information between the electronic device and the selected external electronic device if the plurality of external electronic devices selected based on the image similarity are included in the plurality of external electronic devices, and identify the selected one external electronic device as the target electronic device.

In accordance with another aspect of the disclosure, a method of controlling an electronic device is provided. The method includes camera-capturing an image of a target electronic device among a plurality of external electronic devices capable of performing network connection, obtaining a camera-captured image of the target electronic device and camera-capture time information corresponding to the camera-captured image, obtaining a screen-captured image and screen-capture time information corresponding to the screen-captured image from each of the plurality of external electronic devices, comparing image similarity between the camera-captured image and the screen-captured image obtained from each of the plurality of external electronic devices based on the camera-capture time information and the screen-capture time information, and identifying an external electronic device selected from the plurality of external electronic devices based on the image similarity as the target electronic device, and performing communication connection with the selected external electronic device.

The method further includes transmitting a signal for requesting the screen-captured image and the screen-capture time information to each of the plurality of external electronic devices while the image of the target electronic device is camera-captured.

The method further includes storing the plurality of camera-captured images obtained during a predetermined time and the plurality of camera-capture time information respectively corresponding to the camera-captured images. The comparing of the image similarity between the obtained camera-captured image and the screen-captured images includes obtaining matching time information by selecting the camera-capture time information matching the screen-capture time information from the plurality of camera-capture time information if the screen-captured image and the screen-capture time information are obtained from each of the plurality of external electronic devices, obtaining the camera-captured image corresponding to the matching time information, and comparing the similarity between the obtained camera-captured image and the screen-captured image.

The method further includes transmitting a signal for requesting keypoint information of an image displayed on each screen and detection time information corresponding to the keypoint information to each of the plurality of external electronic devices. The comparing of the image similarity between the obtained camera-captured image and the screen-captured images includes obtaining keypoint information of the camera-captured image, and comparing image similarity between the keypoint information obtained from the external electronic device and the keypoint information of the camera-captured image if the keypoint information of each screen image and the detection time information are obtained from each of the plurality of external electronic devices.

The performing of the communication connection with the selected external electronic device includes selecting an external electronic device whose image similarity is greater than or equal to a reference value from the plurality of external electronic devices, and identifying the selected external electronic device as the target electronic device.

The selecting of the external electronic device whose image similarity is greater than or equal to the reference value includes periodically transmitting a signal for requesting the screen-captured image and the screen-capture time information to each of the plurality of external electronic devices if the external electronic device whose image similarity is greater than or equal to the reference value is not selected from the plurality of external electronic devices, comparing the similarity between the camera-captured image and the screen-captured image periodically received from each of the plurality of external electronic devices based on the screen-capture time information, and selecting the external electronic device whose image similarity is greater than or equal to the reference value based on the image similarity for the periodically received screen-captured images.

The method further includes storing a prior camera-captured image information obtained by previously camera-capturing the images of the plurality of external electronic devices. The selecting of the external electronic device whose image similarity is greater than or equal to the reference value includes obtaining a background image included in the camera-captured image if the plurality of external electronic devices selected based on the image similarity are included in the plurality of external electronic devices, obtaining a background image included in the prior camera-captured image information of the plurality of selected external electronic devices, comparing similarity between the background image included in the obtained prior camera-captured image information and the background image included in the camera-captured image, and selecting one of the plurality of selected external electronic devices based on the image similarity between the background images.

The selecting of the external electronic device whose image similarity is greater than or equal to the reference value includes selecting one external electronic device based on signal strength information between the electronic device and the selected external electronic devices if the plurality of external electronic devices selected based on the image similarity are included in the plurality of external electronic devices.

The selecting of the external electronic device whose image similarity is greater than or equal to the reference value includes selecting one external electronic device based on distance information between the electronic device and the selected external electronic device if the plurality of external electronic devices selected based on the image similarity are included in the plurality of external electronic devices.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include camera-capturing an image of a target electronic device among a plurality of external electronic devices capable of performing network connection, obtaining a camera-captured image of the target electronic device and camera-capture time information corresponding to the camera-captured image, obtaining a screen-captured image and screen-capture time information corresponding to the screen-captured image from each of the plurality of external electronic devices, comparing image similarity between the camera-captured image and the screen-captured image obtained from each of the plurality of external electronic devices based on the camera-capture time information and the screen-capture time information, and identifying an external electronic device selected from the plurality of external electronic devices based on the image similarity as the target electronic device, and performing communication connection with the selected external electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a configuration of a network system according to an embodiment of the disclosure;

FIG. 2 is a block diagram illustrating a configuration of an electronic device according to an embodiment of the disclosure;

FIGS. 3 and 4 are diagrams illustrating an operation for identifying a target electronic device based on image similarity according to various embodiments of the disclosure;

FIG. 5 is a block diagram illustrating a specific configuration of an electronic device according to an embodiment of the disclosure;

FIG. 6 is a diagram illustrating a secondary identification operation of a target electronic device according to an embodiment of the disclosure;

FIG. 7 is a block diagram illustrating a configuration of an external electronic device according to an embodiment of the disclosure; and

FIGS. 8, 9, 10, and 11 are flowcharts illustrating a control method of an electronic device according to various embodiments of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

General terms that are currently widely used are selected as terms used in embodiments of the disclosure their functions in the disclosure, and may be changed based on the intention of those skilled in the art or a judicial precedent, the emergence of a new technique, or the like. In addition, in a specific case, terms arbitrarily chosen by an applicant may exist. In this case, the meanings of such terms are mentioned in corresponding descriptions of the disclosure. Therefore, the terms used in the disclosure need to be defined based on the meanings of the terms and the contents throughout the disclosure rather than simple names of the terms.

In the disclosure, the expression, such as “have”, “may have”, “include”, or “may include”, indicates the presence of a corresponding feature (for example, a numerical value, a function, an operation, or a component, such as a part), and does not exclude the presence of an additional feature.

In the disclosure, the expression, such as “A or B”, “least one of A and/or B”, or “one or more of A and/or B” may include all possible combinations of items enumerated together. For example, “A or B”, “at least one of A and B”, or “at least one of A or B” may indicate all of 1) a case in which at least one A is included, 2) a case in which at least one B is included, or 3) a case in which both of at least one A and at least one B are included.

The expressions, such as “first” and “second”, used in the disclosure, may indicate various components regardless of the sequence and/or importance of the components. These expressions are only used to distinguish one component and another component from each other, and do not limit the corresponding components.

If any component (for example, a first component) is mentioned to be “(operatively or communicatively) coupled with/to” or “connected to” another component (for example, a second component), it should be understood that the any component is directly coupled to another component or may be coupled to another component through yet another component (for example, a third component).

It should be understood that a term “include” or “have” used in this application specifies the presence of features, numerals, steps, operations, components, parts, or combinations thereof, which are mentioned in the specification, and does not preclude the presence or addition of one or more other features, numerals, steps, operations, components, parts, or combinations thereof.

In the disclosure, a “module” or a “˜er/˜or” may perform at least one function or operation, and be implemented by hardware, software, or a combination of hardware and software. In addition, a plurality of “modules” or a plurality of “˜ers/˜ors” may be integrated in at least one module and be implemented by the processor (not shown) except for a “module” or a “˜er/or” that needs to be implemented by a specific hardware.

Hereinafter, an embodiment of the disclosure is described with reference to the accompanying drawings.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

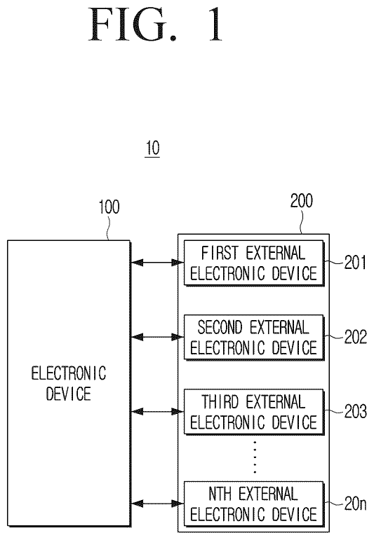

FIG. 1 is a block diagram illustrating a configuration of a network system according to an embodiment of the disclosure.

Referring to FIG. 1, a network system 10 may include an electronic device 100 and a plurality of external electronic devices 200. In this case, the electronic device 100 may be implemented as any of various types of devices, such as a smartphone, a personal digital assistant (PDA), a tablet personal computer (PC), a computer, and a laptop PC. However, the electronic device 100 is not limited thereto, and may include any device capable of camera-capturing an image.

In addition, the plurality of external electronic devices 200 may be electronic devices capable of performing network connection with the electronic device 100. For example, the plurality of external electronic devices 200 may include electronic devices, such as a television (TV), a computer, a laptop, a personal digital assistant (PDA), a tablet PC, and a laptop PC. However, the disclosure is not limited thereto, and the external electronic device may include any device capable of performing network connection with the electronic device 100.

The electronic device 100 may perform communication connection or interworking with at least one external electronic device, and may transmit and receive data to and from the external electronic device to which the communication is connected, or may utilize a function or context of the external electronic device with which the electronic device is interworked. In this case, a user needs to know identity information of a target electronic device to connect the electronic device 100 with the target electronic device among the plurality of external electronic devices 200. If the user knows the identity information of the target electronic device, the user may perform the communication connection by selecting the identity information of the target electronic device from a list of devices with which the electronic device 100 is connectable.

For example, the user may perform the communication connection by selecting the target electronic device among the plurality of external electronic devices 200 to perform interactions, such as interworking, control, pairing, data transmission, and projection between the electronic device 100 and the target electronic device. In this case, the user may identify the target electronic device among the plurality of external electronic devices 200 by using a menu or list displayed on the electronic device 100, and perform the communication connection with the identified target electronic device.

However, the user needs to know the identity information of the target electronic device from the menu or list of connectable devices displayed on the electronic device 100. Therefore, such a method may have low intuitiveness and a significant difference in usage difficulty depending on a user experience.

The electronic device 100 according to various embodiments of the disclosure may camera-capture an image of the target electronic device by using a camera to identify the target electronic device among the plurality of external electronic devices 200 and to perform the communication connection or interworking with the identified target electronic device. For example, the electronic device 100 may camera-capture the image of the target electronic device by using the camera, and identify the target electronic device among the plurality of external electronic devices 200 by comparing similarity between the camera-captured image and screen-captured image of the target electronic device. Alternatively, the electronic device 100 may identify the target electronic device among the plurality of external electronic devices 200 by comparing the similarity between the camera-captured image and screen-captured image of the target electronic device while the camera-captured image of the target electronic device is displayed on the electronic device 100.

Meanwhile, the electronic device 100 may compare the image similarity by using a method of extracting a keypoint of the image and comparing the similarity, and a method of comparing the similarity by using pixel changes in the image. In this case, the keypoint may include the keypoint itself in the image and a descriptor, which is additional information about the keypoint.

The electronic device 100 may detect the keypoint by using a keypoint detection algorithm, such as features from accelerated segment test (FAST). The electronic device 100 may extract the keypoint by setting a point in the image, checking the brightness and darkness around the set point, and checking whether the set point is a corner or a point where brightness changes rapidly. The electronic device 100 may extract the corner or the point where brightness changes rapidly in the image as the keypoint.

For example, the electronic device 100 may select a region having a specific size within the image, virtually draw a circle having a center point (or center) within the selected region as a reference point, and compare the brightness of 16 pixels overlapping an arc of the virtual circle with the brightness of a center point pixel. The electronic device 100 may set the center point as the keypoint if the brightness of the center point pixel is brighter or darker than predetermined reference brightness. For example, the electronic device 100 may set the center point as the keypoint if a specified number or more of pixels brighter than the center point pixel are detected, or a specified number or more of pixels darker than the center point pixel are detected, among the 16 pixels overlapping the arc of the virtual circle.

The electronic device 100 may compare the image similarity by using an algorithm, such as oriented and rotated BRIEF (ORB), scale-invariant feature transform (SIFT), or speeded up robust features (SURF) if the keypoint is extracted from the image. However, the disclosure is not limited thereto, and may use various algorithms for extracting the keypoint from the image or for comparing the image similarity by using the extracted keypoint.

Meanwhile, the oriented and rotated BRIEF (ORB) algorithm may represent a keypoint detection and descriptor generation method based on the features from accelerated segment test (FAST) and binary robust independent elementary features (BRIEF) algorithms. The ORB algorithm may select a point where the brightness of the image changes significantly as the keypoint by using the FAST algorithm, and generate the descriptor for the selected keypoint by using the BRIEF algorithm. In this case, the BRIEF algorithm may generate a binary vector by using comparison between surrounding pixels, and the generated binary vector may be rotated to reflect a direction of the keypoint to provide rotational invariance. The electronic device 100 may detect the keypoint from the image even if the image is rotated, by considering the rotation and direction of the keypoint based on the ORB algorithm.

The scale-invariant feature transform (SIFT) algorithm may represent an algorithm for extracting the keypoint that is robust to changes in scale, rotation, and illumination of the image. The SIFT algorithm may transform the image into multiple scales and then extract the keypoint at each scale by using the FAST algorithm. In addition, the SIFT algorithm may generate the descriptor by calculating the gradient and scale around the extracted keypoint. The SIFT algorithm may also extract an optimal keypoint pair by using a random sample consensus (RANSAC) algorithm. The electronic device 100 may detect the keypoint from the image even if a size of the image changes, based on the SIFT algorithm.

The speeded up robust features (SURF) algorithm may fast filter the image by using Haar wavelet transform. The SURF algorithm may extract the keypoint by using Hessian matrix on the fast filtered image. In addition, the SURF algorithm may generate the descriptor by calculating the gradient and scale around the keypoint, and then extract the optimal keypoint pair by using the RANSAC algorithm.

Meanwhile, if a still image is displayed on a screen of the target electronic device, the electronic device 100 may easily identify the target electronic device by comparing the similarity between the camera-captured image displayed on the electronic device 100 and the screen-captured image of the target electronic device. However, if a video is displayed on the screen of the target electronic device, an error in the image similarity may increase due to a difference between a time of obtaining the camera-captured image displayed on the electronic device 100 and a time of obtaining the screen-captured image, making it difficult to identify the target electronic device through/by using/based on the image similarity.

The electronic device 100 according to the various embodiments of the disclosure may obtain time information corresponding to the camera-captured image displayed on the electronic device 100 and the screen-captured image of the target electronic device, and compare the similarity between the camera-captured image and the screen-captured image based on the obtained time information. Accordingly, the electronic device 100 may identify the target electronic device among the plurality of external electronic devices 200 even if the video is displayed on the screen of the target electronic device.

Meanwhile, if the electronic device 100 receives the screen-captured image and screen-capture time information corresponding to the screen-captured image from the plurality of external electronic devices 200, the electronic device 100 may obtain the identity information of each external electronic device. For example, the electronic device 100 needs to perform the network connection with each of the external electronic devices to transmit and receive data to and from the plurality of external electronic devices 200, and thus obtain the identity information of the plurality of external electronic devices 200.

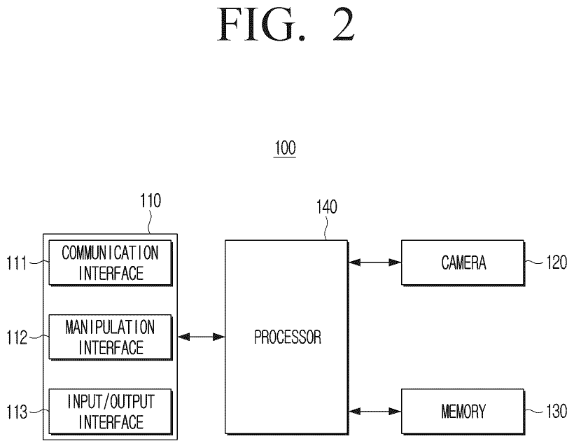

However, if the electronic device 100 camera-captures the image of the target electronic device and displays the camera-captured image on the electronic device 100, the electronic device 100 is unable to select the identity information of the external electronic device corresponding to the camera-captured image based on only the camera-captured image obtained by camera-capturing the target electronic device. Therefore, the electronic device 100 may compare the similarity between the camera-captured image and the screen-captured image, and obtain the identity information of the external electronic device having a higher similarity, thereby identifying the target electronic device among the plurality of external electronic devices 200. The operation of the electronic device 100 identifying the target electronic device among the plurality of external electronic devices 200 is described again with reference to FIGS. 2 to 6 in a section provided below.

In this case, metadata may be included in screen-captured image information transmitted from the plurality of external electronic devices 200 to the electronic device 100. The metadata may include the identity information of the external electronic device transmitting the screen-captured image. In addition, the screen-captured image and the screen-capture time information corresponding to the screen-captured image may be transmitted from the plurality of external electronic devices 200 to the electronic device 100 in the form of separate data, or the metadata including the screen-capture time information may be transmitted from the plurality of external electronic devices 200 to the electronic device 100.

The metadata refers to data that is assigned to content according to a predetermined rule to efficiently retrieve information the user searches for among a large amount of information. The metadata may be used to express data, to rapidly search for desired data among all data, or the like.

FIG. 2 is a block diagram illustrating a configuration of an electronic device according to an embodiment of the disclosure.

Referring to FIG. 2, the electronic device 100 may include an interface 110, a camera 120, memory 130, and a processor 140.

The interface 110 is a component for receiving various data from the user, an external memory, or the external electronic device. For example, the interface 110 may receive the screen-captured image and the screen-capture time information from the plurality of external electronic devices 200.

The interface 110 may include a communication interface 111, a manipulation interface 112, an input/output interface 113, or the like. The communication interface 111 is a component for performing the communication with at least one external electronic device. The communication interface 111 may include at least one wireless communication module, at least one wired communication module, or the like. Each communication module may be implemented in the form of at least one hardware chip. The wireless communication module may include at least one of a wireless fidelity (Wi-Fi) module, a Bluetooth module, an infrared communication module, or other communication modules. In addition, the communication interface 111 may include at least one communication chip for performing the communication according to various wireless communication standards, such as Zigbee, third generation (3G), 3^{rd} generation partnership project (3GPP), long term evolution (LTE), LTE advanced (LTE-A), 4^{th} generation (4G), and 5^{th} generation (5G). The wired communication module may include, for example, at least one of a local area network (LAN) module, an Ethernet module, a pair cable, a coaxial cable, an optical fiber cable, or an ultrawideband (UWB) module. In this way, the communication interface 111 may be implemented in various forms, and may receive a user command from the external electronic device or transmit and receive data by performing the communication with the external electronic device.

The manipulation interface 112 is a component for receiving the user manipulation. The manipulation interface 112 may include various buttons, a touchscreen, or the like disposed on a main body of the electronic device 100. The user may control the operation of the electronic device 100 by using the manipulation interface 112, or control the communication interface 111 or the input/output interface 113 to allow the electronic device 100 to receive data from the plurality of external electronic devices 200. For example, the user may control an operation of the camera 120 by using the manipulation interface 112, or transmit a signal for requesting the screen-captured image and the screen-capture time information to each of the plurality of external electronic devices 200. The manipulation interface 112 may also receive the user signal while the camera-captured image of the target electronic device is displayed on a display.

The input/output interface 113 is a component for inputting and outputting various external signals. The input/output interface may be connected to various external memories or external sources (for example, home appliances, mobile devices, web servers, or user terminal devices) and transmit and receive various data. The input/output interface 113 may be implemented as at least one of a high definition multimedia interface (HDMI), a mobile high-definition link (MHL), a universal serial bus (USB), a USB C-type, a display port (DP), Thunderbolt, a video graphics array (VGA) port, a red-green-blue (RGB) port, a D-subminiature (D-SUB), or a digital visual interface (DVI). The electronic device 100 may transmit and receive data to and from the external memory or external source connected through the input/output interface 113.

The camera 120 is a component for camera-capturing an image. The camera 120 may include at least one lens, an image sensor, an image signal processor, or a flash. The processor 140 may camera-capture the image of the target electronic device by using the camera 120 while the electronic device 100 is in operation.

The memory 130 may store at least one instruction, data, program, or the like required for the operation of the electronic device 100 or the processor 140. In addition, if the image of the target electronic device is camera-captured using the camera 120, the processor 140 may store the plurality of camera-captured images obtained during a predetermined time and the plurality of camera-capture time information respectively corresponding to the camera-captured images in the memory 130.

The memory 130 may be implemented as memory embedded in the electronic device 100 or as memory detachable from the electronic device 100, based on a purpose of data storage. For example, data for operating the electronic device 100 may be stored in the memory embedded in the electronic device 100, and data for expanding functions of the electronic device 100 may be stored in the memory detachable from the electronic device 100.

The memory embedded in the electronic device 100 may be implemented as at least one of volatile memory (e.g., dynamic RAM (DRAM)), static RAM (SRAM), or synchronous dynamic RAM (SDRAM)) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash), hard drive, or solid state drive (SSD)).

The memory 130 may be implemented as single memory that stores data generated from various operations according to the disclosure. However, the memory 130 is not limited thereto, and may be implemented to include a plurality of memories that respectively store different types of data or data generated at different stages.

The processor 140 is a component connected to each component of the electronic device 100 to control overall operations of the electronic device 100. The processor 140 may be implemented as a digital signal processor (DSP), a microprocessor, a graphics-processing unit (GPU), an artificial intelligence (AI) processor, a neural processing unit (NPU), or the like. However, the processor 140 is not limited thereto, and may include at least one of a central processing unit (CPU), a micro controller unit (MCU), a micro processing unit (MPU), a controller, an application processor (AP), or a communication processor (CP), an advanced RISC machine (ARM) processor, or may be defined by a relevant term. In addition, the processor 140 may be implemented as a system-on-chip (SoC) or a large scale integration (LSI), having a processing algorithm embedded therein, an application specific integrated circuit (ASIC), or a field programmable gate array (FPGA).

In addition, if the processor 140 uses a neural network model to compare the similarity between the camera-captured image and screen-captured image of the target electronic device, the processor 140 for executing the neural network model according to an embodiment may be implemented through a combination of software and a general-purpose processor, such as the CPU, the AP, a digital signal processor (DSP), a graphics-only processor, such as the GPU, a vision processing unit (VPU), or a neural network-only processor, such as the NPU.

In this case, the processor 140 may perform control to process input data according to a predefined operation rule stored in the memory or the neural network model. Alternatively, if the processor 140 is implemented as a dedicated processor (or the neural network-only processor), the processor 140 may be designed to have a hardware structure specialized for processing a specific neural network model. For example, hardware specialized for processing a specific neural network model may be designed as a hardware chip, such as the ASIC or the FPGA.

If the processor 140 is implemented as the dedicated processor, the processor 140 may include memory for implementing an embodiment of the disclosure, or may include memory processing function for utilizing the external memory. The processor 140 may be implemented as one or more processors.

The processor 140 may camera-capture the image of the target electronic device by using the camera 120. In this case, the target electronic device may be any one of the plurality of external electronic devices 200.

In addition, the processor 140 may obtain the camera-captured image of the target electronic device and the camera-capture time information corresponding to the camera-captured image and store the same in the memory 130. For example, the processor 140 may obtain the camera-captured image and the camera-capture time information corresponding to the camera-captured image and store the same in the memory 130 while the image of the target electronic device is camera-captured using the camera 120. If the user camera-captures the target electronic device by using the camera 120 during the predetermined time, the processor 140 may obtain the image camera-captured using the camera 120 for each frame at a predetermined interval, obtain camera-capture time information corresponding to each frame, and store the same in the memory 130.

Meanwhile, if the memory 130 for storing the camera-captured image and the camera-capture time information is limited to a predetermined capacity, the processor 140 may delete some data stored in the memory 130 to secure memory capacity for storing the recently obtained camera-captured image and camera-capture time information. In this case, the processor 140 may preferentially store the most recently obtained camera-captured image in the memory 130 based on the camera-capture time information, and preferentially delete the camera-captured image having the oldest camera-capture time from the memory 130.

The processor 140 may obtain the screen-captured images and the screen-capture time information corresponding to the screen-captured images respectively from the plurality of external electronic devices 200 through the interface 110. In this case, the processor 140 may control the interface 110 to transmit the signal for requesting the screen-captured image and the screen-capture time information to each of the plurality of external electronic devices 200 while the image of the target electronic device is camera-captured using the camera 120.

For example, if the processor 140 receives, from the user, the user signal for performing the communication connection with the target electronic device camera-captured using the camera 120 while the image of the target electronic device is camera-captured using the camera 120, the processor 140 may control the communication interface 111 to transmit the signal for requesting the screen-captured image and the screen-capture time information corresponding to the screen-captured image to each of the plurality of external electronic devices 200.

Alternatively, the processor 140 may transmit the signal for requesting the screen-captured image and the screen-capture time information to each of the plurality of external electronic devices 200 after a predetermined waiting time while the image of the target electronic device is camera-captured using the camera 120. More particularly, the processor 140 may transmit the signal for requesting the screen-captured image and the screen-capture time information to each of the plurality of external electronic devices 200 after the predetermined waiting time while a camera-capturing state of performing camera-capturing of the target electronic device by using the camera 120 is maintained during the predetermined waiting time.

In this case, each of the plurality of external electronic devices 200 may screen-capture the image displayed on each screen and transmit the screen-captured image and the screen-capture time information corresponding to the screen-captured image to the electronic device 100.

If the screen-captured image and the screen-capture time information are obtained from each of the plurality of external electronic devices 200, the processor 140 may compare the image similarity between the camera-captured image of the target electronic device and the screen-captured image obtained from each of the plurality of external electronic devices 200 based on the camera-capture time information and the screen-capture time information. For example, the processor 140 may obtain matching time information by comparing the camera-capture time information with the screen-capture time information, and may compare the image similarity between the camera-captured image selected based on the obtained matching time information and the screen-captured image.

The processor 140 may identify, as the target electronic device, the external electronic device selected from the plurality of external electronic devices 200 based on the image similarity, and perform the communication connection with the selected external electronic device. For example, the processor 140 may select the external electronic device whose image similarity is greater than or equal to a reference value from the plurality of external electronic devices 200 based on the image similarity between the camera-captured image and each screen-captured image. In addition, the processor 140 may identify the selected external electronic device as the target electronic device, and perform the communication connection or interworking with the selected external electronic device.

In this case, if one external electronic device whose image similarity is greater than or equal to the reference value is included in the plurality of external electronic devices 200, the processor 140 may identify the selected external electronic device as the target electronic device. However, if a plurality of external electronic devices whose image similarity is greater than or equal to the reference value are included in the plurality of external electronic devices 200, the processor 140 may perform a secondary selection process for selecting one of the plurality of external electronic devices whose image similarity is greater than or equal to the reference value. The operation of the processor 140 selecting one of the plurality of external electronic devices whose image similarity is greater than or equal to the reference value is described in the section provided below.

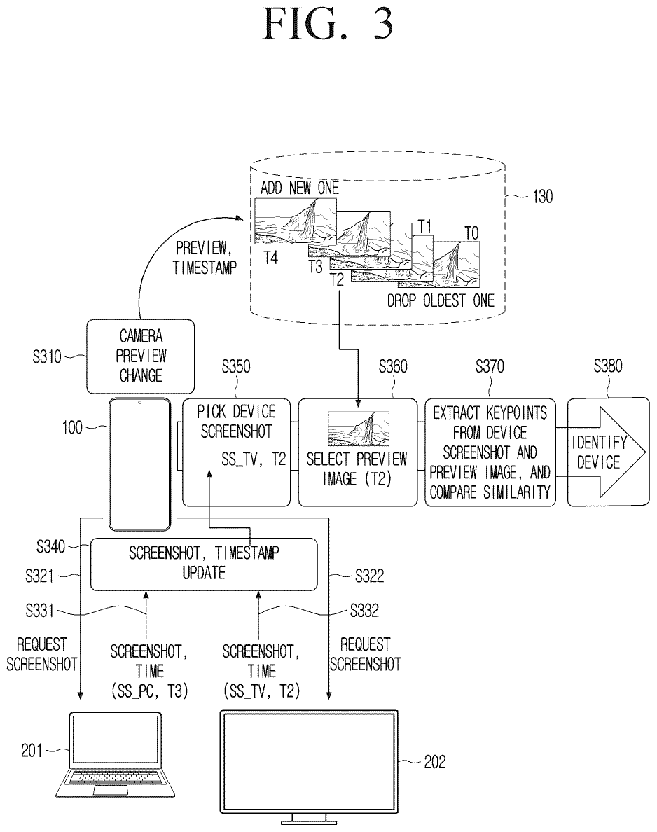

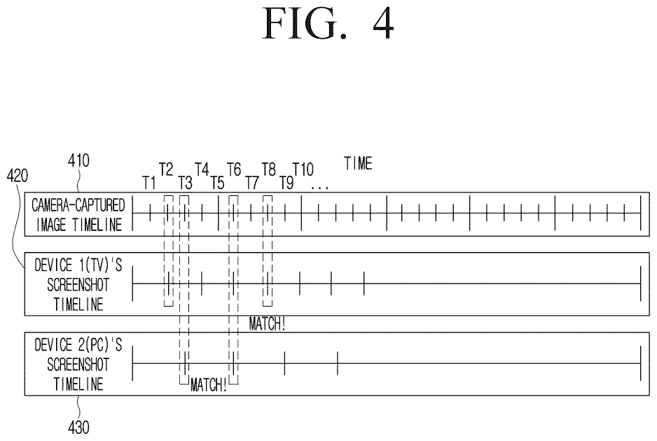

FIGS. 3 and 4 are diagrams illustrating an operation for identifying a target electronic device based on an image similarity according to various embodiments of the disclosure.

Referring to FIG. 3, it is a diagram illustrating the operation of the electronic device 100 obtaining the camera-captured image of the target electronic device, the screen-captured images of the plurality of external electronic devices 200, and the time information corresponding to each image. FIG. 3 shows the camera-captured image of the target electronic device, obtained by the electronic device 100, as a preview image. However, the camera-captured image is not limited thereto, and may include the image camera-captured using the camera 120, an image detected using various sensors, or the like in addition to the preview image. In addition, in FIG. 3, the screenshot shows the screen-captured image obtained by each of the plurality of external electronic devices 200 screen-capturing the image displayed on each screen.

Referring to FIG. 3, the electronic device 100 may camera-capture the image of the target electronic device during the predetermined time by using the camera 120, and store the plurality of camera-captured images obtained during the predetermined time and the plurality of camera-capture time information respectively corresponding to the camera-captured images in the memory 130 in operation S310. If the number of camera-captured images camera-captured during the predetermined time is N, the electronic device 100 may store N camera-captured images and N camera-capture time information (or N timestamps) respectively corresponding to the camera-captured images in the memory 130. For example, FIG. 3 shows that the electronic device 100 stores camera-capture time information T0 to T4 and the camera-captured images respectively corresponding to the camera-capture time information in the memory 130. In this case, the camera-captured image corresponding to the camera-capture time information TO may represent the oldest image among the camera-captured images stored in the memory 130, and the camera-captured image corresponding to the camera-capture time information T4 may represent the image most recently obtained and added to the memory 130.

Meanwhile, the storage capacity of the memory 130 may limit the number of camera-captured images storable in the memory 130. If the electronic device 100 stores the newly obtained camera-captured images in the memory 130, and all storage spaces of the memory 130 are used, the electronic device 100 may preferentially delete the oldest camera-captured image based on the camera-capture time information of the camera-captured images stored in the memory 130 and store the newly obtained camera-captured image.

For example, referring to FIG. 3, if all the storage spaces of the memory 130 are used, the electronic device 100 may delete the camera-captured image corresponding to the oldest camera-capture time information TO among the camera-captured images stored in the memory 130 and store the camera-captured image corresponding to the newly obtained camera-capture time information T4 in the memory 130.

Referring to FIG. 3, the electronic device 100 may transmit a signal for requesting the screen-captured image and the screen-capture time information to a plurality of external electronic devices 201 and 202 in operations S321 and S322. The electronic device 100 may simultaneously transmit the signal for requesting the screen-captured image and the screen-capture time information to the plurality of external electronic devices 201 and 202, or may transmit the signal for requesting the screen-captured image and the screen-capture time information to the external electronic devices 201 and 202 at different times.

If the signal for requesting the screen-captured image and the screen-capture time information is received from the electronic device 100, the plurality of external electronic devices 201 and 202 may screen-capture the image displayed on the respective screens and transmit the screen-captured images and the screen-capture time information corresponding to the screen-captured images together to the electronic device 100 in operations S331 and S332.

Referring to FIG. 3, the first external electronic device 201 may transmit screen-capture time information T3 and a screen-captured image SS_PC screen-captured at time T3 to the electronic device 100, and the second external electronic device 202 may transmit screen-capture time information T2 and a screen-captured image SS_TV screen-captured at time T2 to the electronic device 100.

The electronic device 100 may obtain the screen-captured images and the screen-capture time information respectively from the plurality of external electronic devices 201 and 202, and update the screen-captured images and the screen-capture time information stored in the memory 130 in operation S341. For example, if the storage space of the memory 130 is insufficient, the electronic device 100 may sequentially delete the oldest screen-captured image and the screen-capture time information among the screen-captured images and the screen-capture time information stored in the memory 130, and store the screen-captured images and the screen-capture time information newly obtained from the plurality of external electronic devices 201 and 202 in the memory 130 in operation S340.

In addition, the electronic device 100 may obtain one of the screen-captured images and the screen-capture time information stored in the memory 130 in operations S350, and the electronic device 100 may select a corresponding camera-captured image from the plurality of camera-captured images stored in the memory 130 based on the obtained screen-capture time information in operations S360. For example, if the screen-capture time information obtained from the first external electronic device 201 is T3, the electronic device 100 may select the camera-captured image whose camera-capture time information corresponds to T3 from the camera-captured images stored in the memory 130. Similarly, if the screen-capture time information obtained from the second external electronic device 202 is T2, the electronic device 100 may select the camera-captured image whose camera-capture time information corresponds to T2 from the camera-captured images stored in the memory 130.

Referring to FIG. 3, the electronic device 100 may obtain the screen-capture time information T2 from the second external electronic device 202 to identify whether the second external electronic device 202 is the target electronic device, and select the camera-captured image whose camera-capture time information corresponds to T2 from the camera-captured images stored in the memory 130 in operation S360. However, the disclosure is not limited thereto, and the electronic device 100 may sequentially select the corresponding camera-capture time information and the camera-captured image among the camera-captured images stored in the memory 130 based on the screen-captured image and the screen-capture time information obtained from each of the plurality of external electronic devices 200.

The electronic device 100 may compare the similarity between the camera-captured image and each screen-captured image based on the screen-capture time information in operation S370. For example, if the electronic device 100 obtains the screen-captured image and the camera-captured image corresponding to the screen-capture time information T2, the electronic device 100 may perform the similarity comparison between the camera-captured image and the screen-captured image at time T2 in operation S370.

In this case, the electronic device 100 may transmit a signal for requesting keypoint information of the image displayed on each screen and detection time information corresponding to the keypoint information to each of the plurality of external electronic devices 200 through the interface 110, and the electronic device 100 may also receive the keypoint information of each screen image and the detection time information from each of the plurality of external electronic devices 201 and 202.

The electronic device 100 may obtain keypoint information of the camera-captured image stored in the memory 130. If the electronic device 100 obtains the keypoint information of each screen image and the detection time information from each of the plurality of external electronic devices 201 and 202, the electronic device 100 may compare the image similarity between the keypoint information obtained from the plurality of external electronic devices 201 and 202 and the keypoint information of the camera-captured image.

If the external electronic device whose image similarity is greater than or equal to the reference value is selected, the electronic device 100 may identify the selected external electronic device as the target electronic device in operations S380.

FIG. 4 is a diagram illustrating a matching time information used for matching the camera-capture time information with the screen-capture time information according to an embodiment of the disclosure. For example, FIG. 4 shows camera-capture time information 410 of the electronic device 100, screen-capture time information 420 of the first external electronic device 201, and screen-capture time information 430 of the second external electronic device 202.

If the electronic device 100 compares the image similarity between the camera-captured image and the screen-captured image, an error occurring in the image similarity may increase as a time difference between the camera-capture time and the screen-capture time increases. Therefore, the electronic device 100 may synchronize or match the camera-capture time information with the screen-capture time information to increase the accuracy of the image similarity.

Referring to FIG. 4, if the electronic device 100 camera-captures the image of the target electronic device by using the camera 120, the electronic device 100 may store, in the memory 130, the plurality of camera-captured images obtained during the predetermined time and the plurality of camera-capture time information respectively corresponding to the camera-captured images. For example, the electronic device 100 may store the plurality of camera-captured images corresponding to camera-capture times T1 to T10 in the memory 130.

If the electronic device 100 obtains the screen-captured images and the screen-capture time information from the plurality of external electronic devices 200, the electronic device 100 may select the camera-capture time information matching the screen-capture time information from the plurality of camera-capture time information stored in the memory 130. The electronic device 100 may obtain the selected camera-capture time information as the matching time information, and identify the target electronic device by comparing the similarity between the camera-captured image corresponding to the matching time information and the screen-captured image.

For example, if the electronic device 100 obtains the screen-capture time information T2 from the first external electronic device 201, the electronic device 100 may select the camera-capture time information corresponding to time T2 from the plurality of camera-capture time information stored in the memory 130 and set the same as the matching time information. The electronic device 100 may identify whether the first external electronic device 201 is the target electronic device by comparing the similarity between the camera-captured image corresponding to the matching time information T2 and the screen-captured image obtained from the first external electronic device 201. In addition, if the electronic device 100 obtains the screen-capture time information T3 from the second external electronic device 202, the electronic device 100 may select the camera-capture time information corresponding to time T3 from the plurality of camera-capture time information stored in the memory 130 and set the same as the matching time information. The electronic device 100 may identify whether the second external electronic device 202 is the target electronic device by comparing the similarity between the camera-captured image corresponding to the matching time information T3 and the screen-captured image obtained from the second external electronic device 202.

In this case, if the camera-capture time information corresponding to the screen-capture time information is not included in the plurality of camera-capture time information, the electronic device 100 may periodically transmit the signal for requesting the screen-captured image and the screen-capture time information to each of the plurality of external electronic devices 200 during a predetermined time.

Referring to FIG. 4, the electronic device 100 may periodically transmit the signal for requesting the screen-captured image and the screen-capture time information to the first external electronic device 201, and receive the screen-capture time information T2, T4, T6, T8 . . . and the screen-captured image corresponding to each of the screen-capture time information from the first external electronic device 201. In addition, the electronic device 100 may periodically transmit the signal for requesting the screen-captured image and the screen-capture time information to the second external electronic device 202, and receive the screen-capture time information T3, T6, T9 . . . and the screen-captured image corresponding to each of the screen-capture time information from the second external electronic device 202.

If no camera-capture time information matching the screen-capture time information is included in the plurality of camera-capture time information, the electronic device 100 may select the camera-capture time information closest to the screen-capture time information obtained from the plurality of external electronic devices 200 and set the same as the matching time information. In this case, if the time difference between the screen-capture time and a matching time is large, the image similarity may be too low, and the electronic device 100 may therefore set a matching time range based on the screen-capture time information obtained from the plurality of external electronic devices 200 and obtain the matching time information from the camera-capture time information included in the matching time range.

If the electronic device 100 obtains the camera-captured image corresponding to the matching time information and the screen-captured image, the electronic device 100 may identify whether the corresponding external electronic device is the target electronic device by comparing the image similarity between the obtained camera-captured image and the screen-captured image.

If the external electronic device 200 whose image similarity is greater than or equal to the reference value is not selected from the plurality of external electronic devices, the electronic device 100 may control the interface 110 to periodically transmit the signal for requesting the screen-captured image and the screen-capture time information to each of the plurality of external electronic devices 200.

In this case, if the screen-captured images and the screen-capture time information are periodically obtained from the plurality of external electronic devices 200, the electronic device 100 may identify the target electronic device by comparing the similarity between the screen-captured image periodically received from each of the plurality of external electronic devices 200 based on the screen-capture time information and the camera-captured image.

The electronic device 100 may synchronize the camera-capture time with the screen-capture time to improve the accuracy of the image similarity. The electronic device 100 may use various protocols, such as a network time protocol (NTP) and a precision time protocol (PTP), to synchronize the times of the electronic device 100 and the plurality of external electronic devices 200.

For example, if the electronic device 100 synchronizes the times of the electronic device 100 and the plurality of external electronic devices 200 by using the network time protocol (NTP), the electronic device 100 and the plurality of external electronic devices 200 may access an NTP server and obtain a current time and a timestamp value from the NTP server. In addition, the electronic device 100 and the plurality of external electronic devices 200 may correct the respective times of the electronic device 100 and the plurality of external electronic devices 200 based on a difference value between the obtained timestamp and each local time, and synchronize the times of the electronic device 100 and the plurality of external electronic devices 200.

The precision time protocol (PTP) refers to a protocol that may synchronize the times of one main device and a plurality of other devices. If the electronic device 100 synchronizes the times of devices by using PTP, one device may serve as the main device, and the remaining devices may synchronize their times based on the time information transmitted from the main device. More particularly, if the electronic device 100 synchronizes the times of the electronic device 100 and the plurality of external electronic devices 200 by using PTP, the processor 140 may periodically transmit its time information to the plurality of external electronic devices 200, and each external electronic device that receives the time information may adjust its time based on the time information received from the processor 140 to synchronize the times of the electronic device 100 and the plurality of external electronic devices 200.

To describe by way of example, the electronic device 100 may transmit a transmission time T1 to the first external electronic device 201 by using a Time Sync Request. The first external electronic device 201 may store a first reception time T2, at which the first external electronic device 201 receives the signal from the electronic device 100, in the memory, and transmit a response time T3 to the electronic device 100 by using a Time Sync Response. The electronic device 100 may store a second reception time T4, at which the electronic device 100 receives the signal from the first external electronic device 201, in the memory, and calculate each time difference (offset) by using Equation 1 below.

$$T 2 - T 1 = Offset + delay \qquad Equation 1$$

$$T 4 - T 3 = - Offset + delay$$

Here, T1 may represent the transmission time at which the signal is transmitted from the electronic device 100 to the plurality of external electronic devices 200, T2 may represent each reception time at which the signal is received by each of the plurality of external electronic devices 200, T3 may represent the response time at which the plurality of external electronic devices 200 transmits a response signal to the electronic device 100, and T4 may represent the reception time at which the electronic device 100 receives the response signal from the plurality of external electronic devices 200. In addition, “delay” may represent a signal transmission delay between the electronic device 100 and the plurality of external electronic devices 200, and “offset” may represent the time difference (offset) between the electronic device 100 and the plurality of external electronic devices 200.

The electronic device 100 may correct the calculated time difference (offset) to synchronize the times of the electronic device 100 and the plurality of external electronic devices 200.

In this way, the electronic device according to the various embodiments of the disclosure may request the screen-captured image and the screen-capture time information corresponding to the screen-captured image from the plurality of external electronic devices 200, and compare the similarity between the camera-captured image and the screen-captured image based on the screen-capture time information obtained from each of the plurality of external electronic devices 200, thereby identifying the target electronic device even if the target electronic device displays a video.

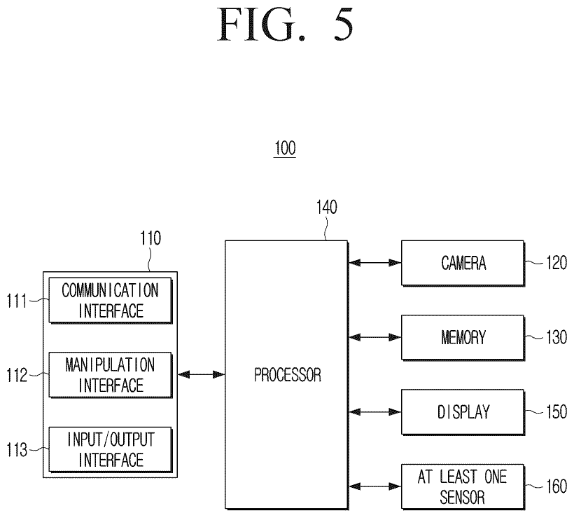

FIG. 5 is a block diagram illustrating a specific configuration of an electronic device according to an embodiment of the disclosure.

Referring to FIG. 5, the electronic device 100 may include the interface 110, the camera 120, the memory 130, the processor 140, a display 150, and at least one sensor 160. Detailed descriptions of the components shown in FIG. 5 that overlap with the components shown in FIG. 2 are omitted.

The display 150 may perform a display operation under the control of the processor 140. For example, while the image of the target electronic device is camera-captured by using the camera 120, the processor 140 may control the display 150 to display the camera-captured image of the target electronic device in real time. In addition, the processor 140 may store the camera-captured image displayed on the display 150 and the camera-capture time information in the memory 130 while the camera-captured image of the target electronic device is displayed on the display 150.

While the camera-captured image of the target electronic device is displayed on the display 150, the processor 140 may control the interface 110 to transmit the signal for requesting the screen-captured images and the screen-capture time information to the plurality of external electronic devices 200. For example, while the camera-captured image of the target electronic device is displayed on the display 150, if the user inputs the user signal for performing the communication connection with the target electronic device displayed on the display 150, the processor 140 may control the communication interface 111 to transmit the signal for requesting the screen-captured images and the screen-capture time information corresponding to the screen-captured images to the plurality of external electronic devices 200.

Alternatively, while the camera-captured image of the target electronic device is displayed on the display 150, the processor 140 may transmit the signal for requesting the screen-captured images and the screen-capture time information to the plurality of external electronic devices 200 after the predetermined waiting time. More particularly, if a state of displaying the target electronic device on the display 150 is maintained for the predetermined waiting time, the processor 140 may transmit the signal for requesting the screen-captured images and the screen-capture time information to the plurality of external electronic devices 200 after the predetermined waiting time.

The display 150 may be implemented as a display including a self-luminous element or a display including a non-luminous element and a backlight. For example, the display 150 may be implemented as various types of displays, such as a liquid crystal display (LCD), an organic light emitting diode (OLED) display, a light-emitting diode (LED) display, a micro LED display, a mini LED display, a plasma display panel (PDP), a quantum dot (QD) display, and a quantum dot light-emitting diode (QLED) display.

At least one sensor 160 is a component for detecting various information related to the operation of the electronic device 100. At least one sensor 160 may collect various surrounding information during the operation of the electronic device 100. At least one sensor 160 may include at least one of a distance sensor, a gyro sensor, an acceleration sensor, a gravity sensor, a geomagnetic sensor, or an image sensor. For example, the distance sensor is a component for sensing a distance between the electronic device 100 and an external object. The electronic device 100 may identify a distance between the electronic device 100 and the plurality of external electronic devices 200 based on a detecting value obtained using the distance sensor. In this case, the distance sensor may include at least one of a light detection and ranging (LiDAR) sensor, an ultrasonic sensor, an infrared sensor, a laser sensor, an optical range sensor, a radio detection and ranging (RADAR) sensor, a photodiode sensor, or a time of flight (TOF) sensor.

For example, the electronic device 100 may control the LiDAR sensor to emit a laser toward the external electronic device. If the laser is reflected from the external electronic device around the electronic device 100 and received by the LiDAR sensor again, the LiDAR sensor may measure the distance between the electronic device 100 and the external electronic device based on a laser reception time.

The ultrasonic sensor may emit ultrasonic waves toward the external electronic device and receive the ultrasonic waves that are reflected from the external electronic device and returned to the ultrasonic sensor. The electronic device 100 may control the ultrasonic sensor to emit the ultrasonic waves toward the external electronic device and analyze the ultrasonic waves that are reflected from the external electronic device and returned to the ultrasonic sensor to measure the distance between the electronic device 100 and the external electronic device. More particularly, the electronic device 100 may calculate the distance between the electronic device 100 and the external electronic device by using a time difference between the output time and reception time of the ultrasonic waves.

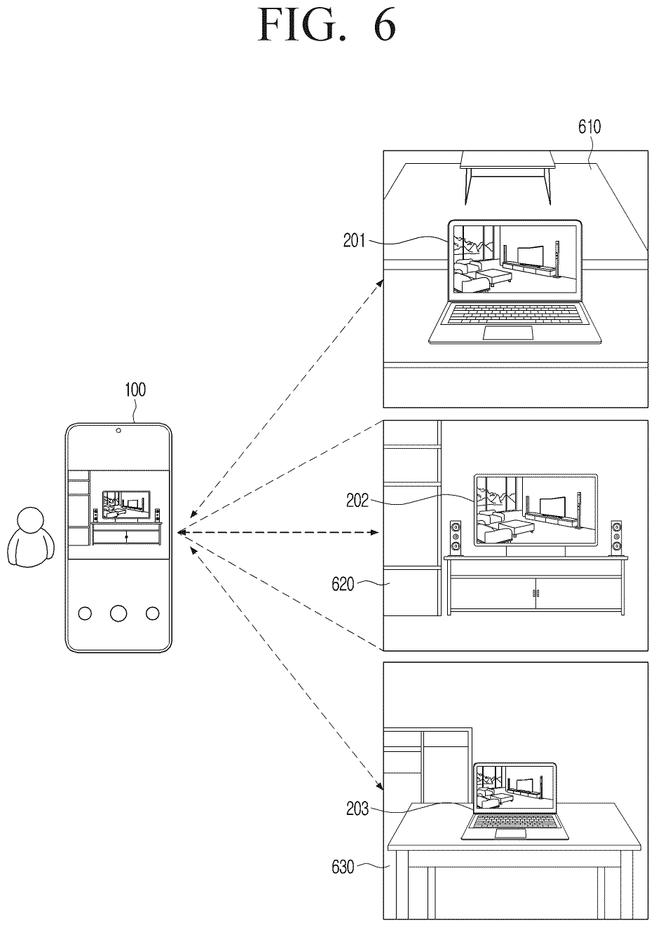

FIG. 6 is a diagram illustrating a secondary identification operation of a target electronic device according to an embodiment of the disclosure.

Referring to FIG. 6, is a diagram illustrating a secondary selection operation for identifying the target electronic device from the plurality of selected external electronic devices if the plurality of external electronic devices are selected based on the image similarity.

If the electronic device 100 obtains the screen-captured images and the screen-capture time information from the plurality of external electronic devices 200, the electronic device 100 may compare the image similarity between each screen-captured image and the camera-captured image, and select the external electronic device whose image similarity is greater than or equal to the reference value from the plurality of external electronic devices 200.

In this case, if one external electronic device whose image similarity is greater than or equal to the reference value is selected, the electronic device 100 may identify the selected external electronic device as the target electronic device.

However, if the plurality of external electronic devices whose image similarity is greater than or equal to the reference value are selected, the electronic device 100 may have difficulty in identifying the target electronic device only by comparing the image similarity between the camera-captured image and the screen-captured image.

For example, if the plurality of external electronic devices 200 capable of performing the network connection with the electronic device 100 are positioned around the electronic device 100, the plurality of external electronic devices 200 may include the external electronic devices that display the same image. Referring to FIG. 5, the plurality of external electronic devices 200 capable of performing the network connection with the electronic device 100 may be positioned around the electronic device 100. In this case, the first external electronic device 201, the second external electronic device 202, and a third external electronic device 203 to an n^{th} external electronic device 20n may be installed in different positions, and may display the same image.

The electronic device 100 may camera-capture the image of the second external electronic device 202 to perform the communication connection or interworking with the second external electronic device 202, and may compare the image similarity between the screen-captured image received from each of the plurality of external electronic devices 200 and the camera-captured image obtained using the second external electronic device 202. However, As shown in FIG. 6, if display images of the first external electronic device 201, the second external electronic device 202, and the third external electronic device 203 among the plurality of external electronic devices 200 are the same, the screen-captured images received by the electronic device 100 from the first external electronic device 201, the second external electronic device 202, and the third external electronic device 203 may be similar, thus making it difficult for the electronic device 100 to identify the target electronic device from the first external electronic device 201, the second external electronic device 202, and the third external electronic device 203 based on the image similarity.

The electronic device 100 may store prior camera-captured image information obtained by previously camera-capturing the images of the plurality of external electronic devices 200 in the memory 130. If the plurality of external electronic devices selected based on the image similarity are included in the plurality of external electronic devices 200, the electronic device 100 may identify the target electronic device by comparing the similarity between a background image included in the prior camera-captured image information of the selected external electronic device and a background image included in the camera-captured image.

For example, as shown in FIG. 6, the electronic device 100 may camera-capture the image of the second external electronic device 202 to perform the communication connection or interworking with the second external electronic device 202. In this case, the images displayed by the first external electronic device 201, the second external electronic device 202, and the third external electronic device 203 may be the same, and the electronic device 100 may thus select three external electronic devices whose image similarity is greater than or equal to the reference value. However, a background image 610 of the first external electronic device 201, a background image 620 of the second external electronic device 202, and a background image 630 of the third external electronic device 203 may be different, and the electronic device 100 may thus compare the image similarity between the background image 620 included in the camera-captured image and the background image included in the prior camera-captured image information, thereby selecting the external electronic device corresponding to the background image 620.

In this case, the prior camera-captured image information may include the identity information of each corresponding external electronic device. For example, if the prior camera-captured image obtained by camera-capturing the image of the second external electronic device 202 is pre-stored in the memory 130, the pre-stored prior camera-captured image information may include the camera-capture time information and the identity information of the second external electronic device 202 used for enabling the electronic device 100 to perform the network connection or interworking with the second external electronic device 202.

Accordingly, the electronic device 100 according to the various embodiments of the disclosure may identify the target electronic device by comparing the image similarity between the background image obtained by camera-capturing the image of the target electronic device and the background image included in the prior camera-captured image even if the plurality of external electronic devices selected based on the image similarity are included in the plurality of external electronic devices 200, or the external electronic devices selected based on the image similarity display the same image.

In this case, the electronic device 100 may identify the target electronic device by comparing the image similarity between the background image obtained by camera-capturing the image of the target electronic device and the background image stored in the memory 130, or may also identify the target electronic device by comparing the similarity between keypoint information of the background image obtained by camera-capturing the image of the target electronic device and keypoint information of the background image included in the prior camera-captured image.

In addition, if the plurality of external electronic devices selected based on the image similarity are included in the plurality of external electronic devices 200, the electronic device 100 may identify the target electronic device from the plurality of external electronic devices based on the physical proximity to the plurality of selected external electronic devices 201, 202, and 203. Here, the physical proximity may indicate a degree of proximity between the electronic device 100 and the plurality of external electronic devices 200, and may include signal strength information, distance information, or the like between the electronic device 100 and the plurality of external electronic devices 200. In addition, the signal strength information may include Wi-Fi delay, Bluetooth low energy received signal strength indicator (BLE RSSI), or the like.

For example, the electronic device 100 may select one of the plurality of external electronic devices 201, 202, and 203 based on the distance information between the plurality of selected external electronic devices 201, 202, and 203 and the electronic device 100, and identify the selected one external electronic device as the target electronic device. If the electronic device 100 camera-captures the image of the target electronic device by using the camera 120 to perform the communication connection or interworking with the target electronic device, the electronic device 100 may approach the vicinity of the target electronic device to camera-capture the image of the target electronic device, and have a relatively close distance to the target electronic device compared to the other external electronic devices. Therefore, the electronic device 100 may identify the external electronic device having the closest distance from the plurality of selected external electronic devices 201, 202, and 203 as the target electronic device.

In this case, the electronic device 100 may detect the distance between the electronic device 100 and the plurality of external electronic devices 200 by using at least one sensor 160. For example, the electronic device 100 may detect the distance between the electronic device 100 and the plurality of external electronic devices 200 by using the distance sensor.

If the plurality of external electronic devices selected based on the image similarity are included in the plurality of external electronic devices 200, the electronic device 100 may select one external electronic device based on the signal strength information between the electronic device 100 and the selected plurality of external electronic devices 201, 202, and 203, and identify the selected one external electronic device as the target electronic device.

If the electronic device 100 camera-captures the image of the target electronic device by using the camera 120 to perform interworking with the target electronic device, the electronic device 100 may approach the vicinity of the target electronic device and a direction of the electronic device 100 may be oriented to the target electronic device, and a signal strength between the electronic device 100 and the target electronic device may be relatively stronger than that between the electronic device 100 and the other external electronic devices. Therefore, the electronic device 100 may identify the external electronic device having the strongest signal strength from the plurality of selected external electronic devices 201, 202, and 203 as the target electronic device.

If the plurality of external electronic devices selected based on the image similarity are included in the plurality of external electronic devices 200, the electronic device 100 may identify the target electronic device from the selected plurality of external electronic devices based on context data of the plurality of selected external electronic devices 201, 202, and 203. For example, the electronic device 100 may perform interworking with the target electronic device among the plurality of external electronic devices 200 to utilize the context data of the target electronic device.

As a result, the electronic device 100 may have a relatively high probability of performing the communication connection or interworking with the external electronic device having the most available context data among the plurality of selected external electronic devices 201, 202, and 203. Accordingly, the electronic device 100 may identify the external electronic device having the most available context data from the plurality of selected external electronic devices 201, 202, and 203 as the target electronic device.

If the plurality of external electronic devices selected based on the image similarity are included in the plurality of external electronic devices 200, the electronic device 100 may identify the target electronic device from the plurality of selected external electronic devices based on identification count information for the plurality of selected external electronic devices 201, 202, and 203. In this case, the memory 130 may pre-store identification count history information between the electronic device 100 and the plurality of external electronic devices 200.

For example, if the electronic device 100 performs interworking with the target electronic device, the user may often perform interworking to reuse previously used functions or contexts. Therefore, the electronic device 100 may have a relatively high probability of performing interworking with the external electronic device that has a large usage history or a large number of identification counts. Accordingly, the electronic device 100 may identify the external electronic device having the largest number of prior identification counts from the plurality of selected external electronic devices 201, 202, and 203 as the target electronic device.

If the plurality of external electronic devices selected based on the image similarity are included in the plurality of external electronic devices 200, the electronic device 100 may identify the target electronic device by using at least one of the image similarity comparison between the background images, the physical proximity, the available context data, or the identification count information to select one external electronic device from the plurality of selected external electronic devices. Alternatively, the electronic device 100 may identify the target electronic device from the plurality of selected external electronic devices by sequentially applying the image similarity comparison between the background images, the physical proximity, the available context data, and the identification count information.

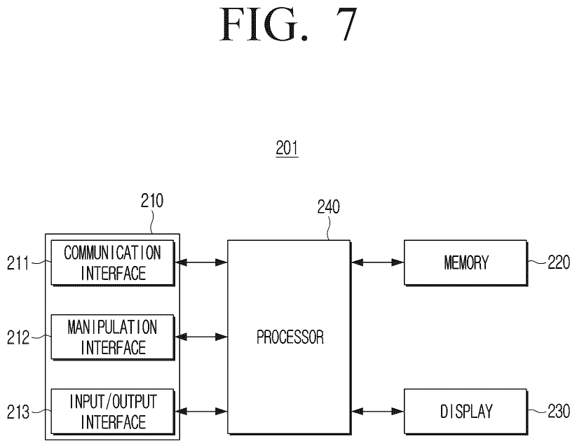

FIG. 7 is a block diagram illustrating a configuration of an external electronic device according to an embodiment of the disclosure. The description is provided based on the first external electronic device 201 among the plurality of external electronic devices 200 with reference to FIG. 7.

Referring to FIG. 7, the first external electronic device 201 may include an interface 210, memory 220, a display 230, and a processor 240. However, the disclosure is not limited thereto, and the first external electronic device 201 may further include various components to provide functions or contexts required by the electronic device 100. Detailed descriptions of the components shown in FIG. 7 that overlap with those shown in FIGS. 2 and 5 are omitted.

The interface 210 is a component for receiving various data from the user, the external memory, or the external electronic device, or for transmitting data to the external electronic device. The interface 210 may receive the user command, or transmit and receive a signal to and from the electronic device 100. The interface 210 may include a communication interface 211, a manipulation interface 212, an input/output interface 213, or the like. The memory 220 may store at least one instruction, data, program, or the like required for operating the first external electronic device 201 or the processor 240.

The display 230 may perform the display operation under the control of the processor 240. The display 230 may be implemented as a display including a self-luminous element or a display including a non-luminous element and a backlight. For example, the display may be implemented as various types of displays, such as a liquid crystal display (LCD), an organic light emitting diode (OLED) display, a light-emitting diode (LED) display, a micro LED display, a mini LED display, a plasma display panel (PDP), a quantum dot (QD) display, and a quantum dot light-emitting diode (QLED) display.

The processor 240 is a component that is connected to each component of the first external electronic device 201 and controls overall operations of the first external electronic device 201. The processor 240 can be implemented as one or more processors. If the signal for requesting the screen-captured image and the screen-capture time information is received from the electronic device 100, the processor 240 may screen-capture the image displayed on the display 230, and transmit the screen-captured image and the screen-capture time information corresponding to the screen-captured image to the electronic device 100 through the interface 210. Alternatively, if the signal for requesting the keypoint information of the screen-captured image and the detection time information corresponding to the keypoint information is received from the electronic device 100, the processor 240 may obtain the keypoint information of the screen-captured image and the detection time information and transmit the same to the electronic device 100.

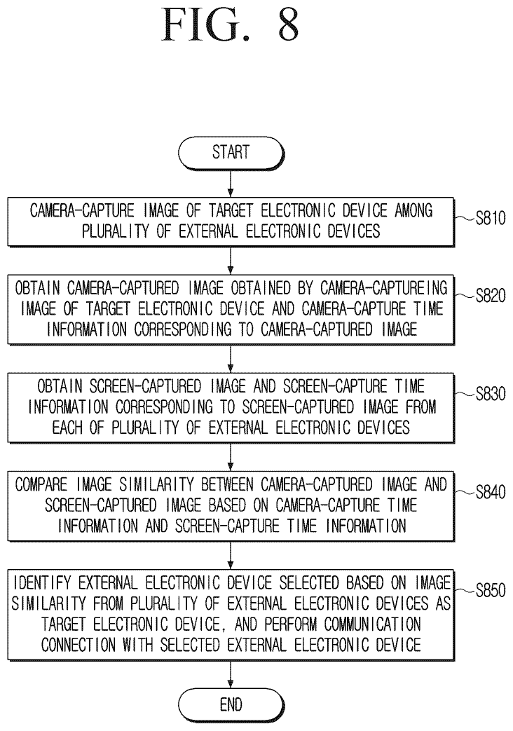

FIGS. 8 to 11 are flowcharts illustrating a control method of an electronic device according to various embodiments of the disclosure.

The user may select the target electronic device from the plurality of external electronic devices capable of performing the network connection with the electronic device to perform the communication connection or interworking with the electronic device. For example, the user may select the target electronic device from the menu or device list of the plurality of external electronic devices displayed on the electronic device to perform the communication connection between the electronic device and the target electronic device. However, the user needs to know the identity information of the target electronic device to select the target electronic device from the menu or device list displayed on the electronic device. Therefore, such a method has low intuitiveness and a large difference in the usage difficulty depending on the user experience.

The electronic device according to the various embodiments of the disclosure may camera-capture the image of the target electronic device by using the camera, identify the target electronic device based on the camera-captured image, and perform the communication connection or interworking with the identified target electronic device.

Referring to FIG. 8, the electronic device may camera-capture the image of the target electronic device from the plurality of external electronic devices capable of performing the network connection by using the camera at operation S810. In addition, the electronic device may obtain the camera-captured image obtained by camera-capturing the image the target electronic device and the camera-capture time information corresponding to the camera-captured image at operation S820.

For example, while the electronic device camera-captures the image of the target electronic device, the electronic device may obtain the camera-captured image obtained by camera-capturing the image the target electronic device and the camera-capture time information and store the same in the electronic device. If the electronic device camera-captures the image of the target electronic device by using the camera, the electronic device may store the plurality of camera-captured images obtained during the predetermined time and the plurality of camera-capture time information respectively corresponding to the camera-captured images in the electronic device. In this case, the electronic device may obtain the image camera-captured using the camera for each frame of the predetermined interval, obtain camera-capture time information corresponding to each frame together, and store the same in the electronic device.

While the electronic device camera-captures the image of the target electronic device, the electronic device may transmit the signal for requesting the screen-captured image and the screen-capture time information corresponding to the screen-captured image to each of the plurality of external electronic devices. In this case, each of the plurality of external electronic devices may screen-capture the image displayed on the screen, and transmit the screen-captured image and the screen-capture time information corresponding to the screen-captured image to the electronic device.

For example, while the electronic device camera-captures the image of the target electronic device, if the user signal for performing the communication connection with the target electronic device is input, the electronic device may transmit the signal for requesting the screen-captured image and the screen-capture time information to each of the plurality of external electronic devices. Alternatively, while the electronic device camera-captures the image of the target electronic device, if the input signal is not received from the user within the predetermined waiting time, the electronic device may transmit the signal for requesting the screen-captured image and the screen-capture time information to each of the plurality of external electronic devices after the waiting time.

The electronic device may transmit the signal for requesting the keypoint information and the detection time information corresponding to the keypoint information of the image displayed on each screen to each of the plurality of external electronic devices while camera-capturing the image of the target electronic device. In this case, each of the plurality of external electronic devices may obtain the keypoint information of the image displayed on the screen, and transmit the obtained keypoint information and the detection time information corresponding to the keypoint information obtained from the image to the electronic device.

The electronic device may obtain the screen-captured image and the screen-capture time information corresponding to the screen-captured image from each of the plurality of external electronic devices at operation S830

In addition, if the electronic device obtains the screen-captured images and the screen-capture time information from the plurality of external electronic devices, the electronic device may compare the image similarity between the camera-captured image and the screen-captured image obtained from each of the plurality of external electronic devices based on the camera-capture time information and the screen-capture time information at operation S840. For example, the electronic device may obtain the matching time information by comparing the camera-capture time information with the screen-capture time information, and compare the image similarity between the selected camera-captured image and the screen-captured image based on the obtained matching time information.

The electronic device may identify the external electronic device selected from the plurality of external electronic devices based on the image similarity as the target electronic device, and perform the communication connection with the selected external electronic device at operation S850. For example, the electronic device may select the external electronic device whose image similarity is greater than or equal to the reference value from the plurality of external electronic devices, and identify the selected external electronic device as the target electronic device. In this case, if one external electronic device whose image similarity is greater than or equal to the reference value is included the plurality of external electronic devices, the electronic device may identify the selected one external electronic device as the target electronic device.

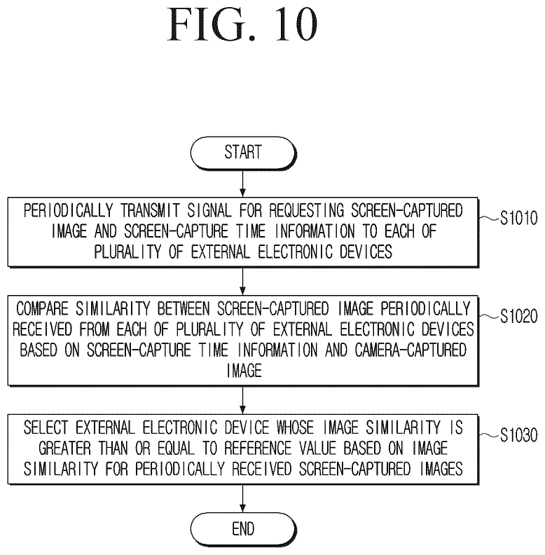

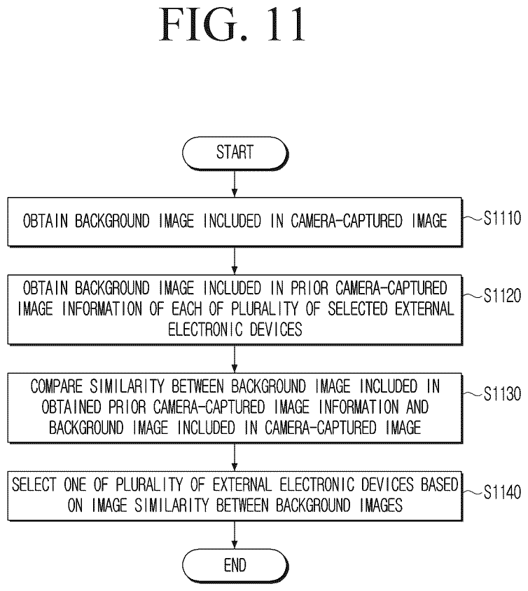

However, if the plurality of external electronic devices whose image similarity is greater than or equal to the reference value are included in the plurality of external electronic devices, the electronic device needs to perform the secondary selection process for selecting one external electronic device from the plurality of selected external electronic devices. A secondary selection method for the electronic device to select one of the plurality of selected external electronic devices is described again with reference to FIGS. 10 and 11 in the section provided below.

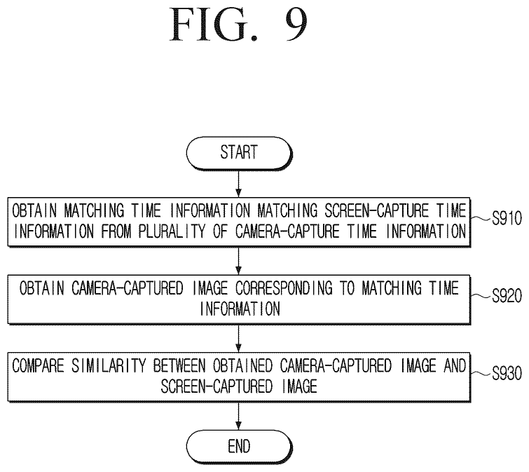

FIG. 9 is a flowchart illustrating a method for comparing an image similarity between a screen-captured images obtained from each of a plurality of external electronic devices and a camera-captured image obtained by an electronic device according to the various embodiments of the disclosure. More particularly, FIG. 9 is a diagram illustrating the method for the electronic device to select the camera-captured image matching the screen-captured image from the plurality of camera-captured images obtained during the predetermined time and comparing the image similarity.

If the electronic device obtains the screen-captured image and the screen-capture time information from each of the plurality of external electronic devices, and the screen-capture time information matches the camera-capture time information, the electronic device may compare the image similarity between the camera-captured image and the screen-captured image based on the matching time information, and identify the target electronic device based on the image similarity. However, if the screen-capture time information does not match the camera-capture time information, it may be difficult for the electronic device to identify the target electronic device based on the image similarity because the error in the image similarity increases based on the obtained time difference.

Referring to FIG. 9, if the electronic device obtains the screen-captured image and the screen-capture time information from each of the plurality of external electronic devices, the electronic device may obtain the matching time information by selecting the camera-capture time information matching the screen-capture time information from the plurality of camera-capture time information at operation S910. In this case, if the camera-capture time information matching the screen-capture time information is included in the plurality of camera-capture time information, the electronic device may set the matching camera-capture time information as the matching time information.

However, if the camera-capture time information corresponding to the screen-capture time information is not included in the plurality of camera-capture time information, the electronic device may periodically transmit the signal for requesting the screen-captured image and the screen-capture time information to each of the plurality of external electronic devices during the predetermined time.

Alternatively, if the camera-capture time information matching the screen-capture time information is not included in the plurality of camera-capture time information, the electronic device may select the camera-capture time information closest to the screen-capture time information obtained from the plurality of external electronic devices and set the same as the matching time information. In this case, if the time difference between the screen-capture time and the matching time is large, the image similarity may be too low, and the electronic device may therefore set the matching time range based on the screen-capture time information obtained from the plurality of external electronic devices, and also obtain the matching time information from the camera-capture time information included in the matching time range.

The electronic device may obtain the camera-captured image corresponding to the matching time information from the plurality of camera-captured images in operations S920. More particularly, if the electronic device obtains the matching time information matching the screen-capture time information from the plurality of camera-capture time information, the electronic device may obtain the camera-captured image corresponding to the matching time information from the plurality of camera-captured images.

The electronic device may compare the similarity between the obtained camera-captured image and the screen-captured image at operation S930.

In this case, the electronic device may obtain the keypoint information of the camera-captured image. The electronic device may transmit, to each of the plurality of external electronic devices, the signal for requesting the keypoint information of the image displayed on each screen and the detection time information corresponding to the keypoint information.

In addition, if the electronic device obtains the keypoint information of each screen image and the detection time information corresponding to the keypoint information from the plurality of external electronic devices, the electronic device may compare the image similarity of the keypoint information obtained from the external electronic device and the keypoint information for the camera-captured image.

FIGS. 10 and 11 are diagrams illustrating a secondary selection method for selecting one of a plurality of external electronic devices based on an image similarity. For example, FIG. 10 is a diagram illustrating a method for obtaining the screen-captured image whose image similarity is greater than or equal to the reference value if the external electronic device whose image similarity is greater than or equal to the reference value is not selected from the plurality of external electronic devices.

Referring to FIG. 10, if the external electronic device whose image similarity is greater than or equal to the reference value is not selected from the plurality of external electronic devices, the electronic device may periodically transmit the signal for requesting the screen-captured image and the screen-capture time information to each of the plurality of external electronic devices at operation S1010. In addition, if the electronic device periodically obtains the screen-captured image and the screen-capture time information from each of the plurality of external electronic devices, the electronic device may compare the similarity between the screen-captured image periodically received from each of the plurality of external electronic devices based on the screen-capture time information and the camera-captured image at operation S1020.

In this case, if the external electronic device whose image similarity is greater than or equal to the reference value is not selected from the plurality of external electronic devices during the predetermined screen-capture cycle time, the electronic device may adjust the reference value for the image similarity. For example, the electronic device may select the external electronic device whose image similarity is greater than or equal to the reference value from the plurality of external electronic devices by decreasing the reference value for the image similarity.

The electronic device may select the external electronic device whose image similarity is greater than or equal to the reference value based on the image similarity between the periodically received screen-captured images and the camera-captured image at operation S1030, and identify the selected external electronic device as the target electronic device.

FIG. 11 is a diagram illustrating a method for selecting one of a plurality of external electronic devices if a plurality of external electronic devices selected based on an image similarity are included in a plurality of external electronic devices.

The electronic device may store the prior camera-captured image information obtained by previously camera-capturing the images of the plurality of external electronic devices. In this case, the prior camera-captured image information may include the background image of each external electronic device. In addition, the prior camera-captured image information may also include the identity information of each external electronic device.

Referring to FIG. 11, if the plurality of external electronic devices selected based on the image similarity are included in the plurality of external electronic devices, the electronic device may obtain the background image included in the camera-captured image at operation S1110. In addition, the electronic device may obtain the background image included in the prior camera-captured image information of each of the plurality of selected external electronic devices at operation S1120.

For example, if the plurality of selected external electronic devices display the same image, it may be difficult for the electronic device to identify the target electronic device based on the image similarity for the screen-captured images because the screen-captured images received from the plurality of selected external electronic devices are similar to each other. However, even if the plurality of selected external electronic devices display the same image, the background image of each external electronic device may be different, and the electronic device may thus compare the similarity between the background image included in the obtained prior camera-captured image information and the background image included in the camera-captured image at operation S1130.

In addition, the electronic device may select one of the plurality of external electronic devices based on the image similarity between the background images at operation S1140, and identify the selected one external electronic device as the target electronic device.

If the plurality of external electronic devices selected based on the image similarity are included in the plurality of external electronic devices, the electronic device may select one external electronic device based on the signal strength information between the electronic device and the selected external electronic device. For example, if the electronic device camera-captures the image of the target electronic device, the signal strength between the electronic device and the target electronic device may be relatively stronger than that between the electronic device and the other external electronic devices because the user approaches near the target electronic device and the camera-capture direction of the electronic device may be oriented to the target electronic device. Therefore, the electronic device may identify the external electronic device having the strongest signal strength from the plurality of selected external electronic devices as the target electronic device.

If the plurality of external electronic devices selected based on the image similarity are included in the plurality of external electronic devices, the electronic device may select one external electronic device based on the distance information between the electronic device and the selected external electronic device. For example, if the electronic device camera-captures the image of the target electronic device to establish the communication connection with the target electronic device, the user may approach the vicinity of the target electronic device to camera-capture the image of the target electronic device, and the electronic device may have the relatively close distance to the target electronic device compared to the other external electronic devices. Therefore, the electronic device may identify the external electronic device having the closest distance from the plurality of external electronic devices as the target electronic device.

In this way, the electronic device and the control method thereof according to the various embodiments of the disclosure may camera-capture the image of the target electronic device by using the camera, or identify the target electronic device based on the camera-captured image while the camera-captured image of the target electronic device is displayed on the display, and perform the communication connection or interworking with the identified target electronic device.

Meanwhile, according to an embodiment of the disclosure, the various embodiments described above may be implemented in software including an instruction stored on a machine-readable storage medium (for example, a computer-readable storage medium). A machine may be a device that invokes the stored instruction from a storage medium, may be operated based on the invoked instruction, and may include the electronic device according to the disclosed embodiments. If the instruction is executed by the processor, the processor may directly perform a function corresponding to the instruction or other components may perform the function corresponding to the instruction under control of the processor. The instruction may include codes provided or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored on the storage medium.

In addition, according to an embodiment of the disclosure, the methods according to the various embodiments described above may be included and provided in a computer program product. The computer program product may be traded as a commodity between a seller and a purchaser. The computer program product may be distributed in a form of the machine-readable storage medium (for example, compact disc read only memory (CD-ROM)), or may be distributed online through an application store (for example, PlayStore™). In case of the online distribution, at least a part of the computer program product may be at least temporarily stored or temporarily provided on a storage medium, such as the memory of a manufacturer server, an application store server, or a relay server.

In addition, each of the components (for example, modules or programs) according to the various embodiments described above may include a single entity or a plurality of entities, and some of the corresponding sub-components described above may be omitted or other sub-components may be further included in the various embodiments. Alternatively or additionally, some of the components (for example, the modules or the programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication interface;
a camera;
memory, including one or more storage media, storing instructions; and
at least one processor communicatively coupled to the communication interface, the camera, and the memory,
wherein the instructions, when executed by the at least one processor individually or collectively, cause the electronic device to:
obtain a camera-captured image of a target electronic device obtained by camera-capturing an image of the target electronic device among a plurality of external electronic devices by using the camera and camera-capture time information corresponding to the camera-captured image,
obtain a screen-captured image and screen-capture time information corresponding to the screen-captured image from each of the plurality of external electronic devices through the communication interface,
compare image similarity between the camera-captured image and the screen-captured image obtained from each of the plurality of external electronic devices based on the camera-capture time information and the screen-capture time information, and
identify an external electronic device selected from the plurality of external electronic devices based on the image similarity as the target electronic device, and perform communication connection with the selected external electronic device.

2. The electronic device of claim 1, wherein the instructions, when executed by the at least one processor individually or collectively, further cause the electronic device to control the communication interface to transmit a signal for requesting the screen-captured image and the screen-capture time information to each of the plurality of external electronic devices while the image of the target electronic device is camera-captured using the camera.

3. The electronic device of claim 1,
wherein the memory stores a plurality of camera-captured images obtained during a predetermined time and plurality of camera-capture time information respectively corresponding to the camera-captured images, and
wherein the instructions, when executed by the at least one processor individually or collectively, further cause the electronic device to:
obtain matching time information by selecting the camera-capture time information matching the screen-capture time information from the plurality of camera-capture time information if the screen-captured image and the screen-capture time information are obtained from each of the plurality of external electronic devices, and
identify the target electronic device by comparing the image similarity between the camera-captured image corresponding to the matching time information and the screen-captured image.

4. The electronic device of claim 1, wherein the instructions, when executed by the at least one processor individually or collectively, further cause the electronic device to:
transmit a signal for requesting keypoint information of an image displayed on each screen and detection time information corresponding to the keypoint information to each of the plurality of external electronic devices through the communication interface,
obtain keypoint information of the camera-captured image, and
identify the target electronic device by comparing image similarity between the keypoint information obtained from the plurality of external electronic device and the keypoint information of the camera-captured image if the keypoint information of each screen image and the detection time information are obtained from each of the plurality of external electronic devices.

5. The electronic device of claim 1, wherein the instructions, when executed by the at least one processor individually or collectively, further cause the electronic device to:
select an external electronic device whose image similarity is greater than or equal to a reference value from the plurality of external electronic devices, and
identify the selected external electronic device as the target electronic device.

6. The electronic device of claim 5,
wherein the memory stores a plurality of camera-captured images obtained during a predetermined time and plurality of camera-capture time information respectively corresponding to the camera-captured images, and
wherein the instructions, when executed by the at least one processor individually or collectively, further cause the electronic device to:
control the communication interface to periodically transmit a signal for requesting the screen-captured image and the screen-capture time information to each of the plurality of external electronic devices if the external electronic device whose image similarity is greater than or equal to the reference value is not selected from the plurality of external electronic devices, and
identify the target electronic device by comparing the image similarity between the screen-captured image periodically received from each of the plurality of external electronic devices based on the screen-capture time information and the camera-captured image.

7. The electronic device of claim 5,
wherein the memory stores a prior camera-captured image information obtained by previously camera-capturing images of the plurality of external electronic devices, and
wherein the instructions, when executed by the at least one processor individually or collectively, further cause the electronic device to identify the target electronic device by comparing similarity between a background image included in the prior camera-captured image information of the selected external electronic device and a background image included in the camera-captured image if the plurality of external electronic devices selected based on the image similarity are included in the plurality of external electronic devices.

8. The electronic device of claim 5, further comprising:
a distance sensor configured to detect a distance between the electronic device and the plurality of external electronic devices,
wherein the instructions, when executed by the at least one processor individually or collectively, further cause the electronic device to:
select one external electronic device based on distance information between the electronic device and the selected external electronic device if the plurality of external electronic devices selected based on the image similarity are included in the plurality of external electronic devices, and
identify the selected one external electronic device as the target electronic device.

9. A method of controlling an electronic device, the method comprising:
camera-capturing an image of a target electronic device among a plurality of external electronic devices capable of performing network connection;
obtaining a camera-captured image of the target electronic device and camera-capture time information corresponding to the camera-captured image;
obtaining a screen-captured image and screen-capture time information corresponding to the screen-captured image from each of the plurality of external electronic devices;
comparing image similarity between the camera-captured image and the screen-captured image obtained from each of the plurality of external electronic devices based on the camera-capture time information and the screen-capture time information; and
identifying an external electronic device selected from the plurality of external electronic devices based on the image similarity as the target electronic device, and performing communication connection with the selected external electronic device.

10. The method of claim 9, further comprising:
transmitting a signal for requesting the screen-captured image and the screen-capture time information to each of the plurality of external electronic devices while the image of the target electronic device is camera-captured.

11. The method of claim 9, further comprising:
storing a plurality of camera-captured images obtained during a predetermined time and plurality of camera-capture time information respectively corresponding to the camera-captured images,
wherein the comparing of the image similarity between the obtained camera-captured image and the screen-captured images includes:
obtaining matching time information by selecting the camera-capture time information matching the screen-capture time information from the plurality of camera-capture time information if the screen-captured image and the screen-capture time information are obtained from each of the plurality of external electronic devices;
obtaining the camera-captured image corresponding to the matching time information; and
comparing the image similarity between the obtained camera-captured image and the screen-captured image.

12. The method of claim 9, further comprising:
transmitting a signal for requesting keypoint information of an image displayed on each screen and detection time information corresponding to the keypoint information to each of the plurality of external electronic devices,
wherein the comparing of the image similarity between the obtained camera-captured image and the screen-captured images includes:
obtaining keypoint information of the camera-captured image; and
comparing image similarity between the keypoint information obtained from the plurality of external electronic device and the keypoint information of the camera-captured image if the keypoint information of each screen image and the detection time information are obtained from each of the plurality of external electronic devices.

13. The method of claim 9, wherein the performing of the communication connection with the selected external electronic device includes:
selecting an external electronic device whose image similarity is greater than or equal to a reference value from the plurality of external electronic devices; and
identifying the selected external electronic device as the target electronic device.

14. The method of claim 13, further comprising:
storing a plurality of camera-captured images obtained during a predetermined time and plurality of camera-capture time information respectively corresponding to the plurality of camera-captured images,
wherein the selecting of the external electronic device whose image similarity is greater than or equal to the reference value includes:
periodically transmitting a signal for requesting the screen-captured image and the screen-capture time information to each of the plurality of external electronic devices if the external electronic device whose image similarity is greater than or equal to the reference value is not selected from the plurality of external electronic devices;
comparing the image similarity between the camera-captured image and the screen-captured image periodically received from each of the plurality of external electronic devices based on the screen-capture time information; and
selecting the external electronic device whose image similarity is greater than or equal to the reference value based on the image similarity for the periodically received screen-captured images.

15. The method of claim 13, further comprising:
storing a prior camera-captured image information obtained by previously camera-capturing images of the plurality of external electronic devices,
wherein the selecting of the external electronic device whose image similarity is greater than or equal to the reference value includes:
obtaining a background image included in the camera-captured image if the plurality of external electronic devices selected based on the image similarity are included in the plurality of external electronic devices;
obtaining a background image included in the prior camera-captured image information of the plurality of selected external electronic devices;
comparing similarity between the background image included in the obtained prior camera-captured image information and the background image included in the camera-captured image; and
selecting one of the plurality of selected external electronic devices based on the image similarity between the background images.

16. One or more non-transitory computer-readable storage media storing one or more computer programs including computer-executable instructions that, when executed by one or more processors of an electronic device individually or collectively, cause the electronic device to perform operations, the operations comprising:
camera-capturing an image of a target electronic device among a plurality of external electronic devices capable of performing network connection;
obtaining a camera-captured image of the target electronic device and camera-capture time information corresponding to the camera-captured image;
obtaining a screen-captured image and screen-capture time information corresponding to the screen-captured image from each of the plurality of external electronic devices;
comparing image similarity between the camera-captured image and the screen-captured image obtained from each of the plurality of external electronic devices based on the camera-capture time information and the screen-capture time information; and
identifying an external electronic device selected from the plurality of external electronic devices based on the image similarity as the target electronic device, and performing communication connection with the selected external electronic device.

17. The one or more non-transitory computer-readable storage media of claim 16, the operations further comprising:
transmitting a signal for requesting the screen-captured image and the screen-capture time information to each of the plurality of external electronic devices while the image of the target electronic device is camera-captured.

18. The one or more non-transitory computer-readable storage media of claim 16, the operations further comprising:
storing a plurality of camera-captured images obtained during a predetermined time and plurality of camera-capture time information respectively corresponding to the camera-captured images,
wherein the comparing of the image similarity between the obtained camera-captured image and the screen-captured images includes:
obtaining matching time information by selecting the camera-capture time information matching the screen-capture time information from the plurality of camera-capture time information if the screen-captured image and the screen-capture time information are obtained from each of the plurality of external electronic devices;
obtaining the camera-captured image corresponding to the matching time information; and
comparing the image similarity between the obtained camera-captured image and the screen-captured image.

19. The one or more non-transitory computer-readable storage media of claim 16, the operations further comprising:
transmitting a signal for requesting keypoint information of an image displayed on each screen and detection time information corresponding to the keypoint information to each of the plurality of external electronic devices,
wherein the comparing of the image similarity between the obtained camera-captured image and the screen-captured images includes:
obtaining keypoint information of the camera-captured image; and
comparing image similarity between the keypoint information obtained from the plurality of external electronic device and the keypoint information of the camera-captured image if the keypoint information of each screen image and the detection time information are obtained from each of the plurality of external electronic devices.

20. The one or more non-transitory computer-readable storage media of claim 16, wherein the performing of the communication connection with the selected external electronic device includes:
selecting an external electronic device whose image similarity is greater than or equal to a reference value from the plurality of external electronic devices; and
identifying the selected external electronic device as the target electronic device.
